(19) United States
(12) Patent Application Publication
(10) Pub. No.: US 2006/0069728 A1
(43) Pub. Date: Mar. 30, 2006

(54) System and process for transforming a style of a message

(75) Inventors: Carlos I. McEvilly, Cupertino, CA (US); Jens Nagel, San Francisco, CA (US); Heiko K. Sacher, Menlo Park, CA (US); Rudy Schusteritsch, Mountain View, CA (US); Marie White, Fallen Leaf, CA (US)

Correspondence Address: LAW OFFICES OF CHARLES W. BETHARDS, LLP, P.O. BOX 1622, COLLEYVILLE, TX, 76034, US

(73) Assignee: MOTOROLA, INC.

(21) Appl. No.: 10/931,548

(22) Filed: Aug. 31, 2004

(51) Int. Cl. G06F 15/16

(52) U.S. Cl. 709/206

(57) ABSTRACT

Systems and processes are provided for transforming a style of a message. A processor is configured to facilitate determining a message (111) to be transmitted. Further, the message processor can facilitate selecting one or more styles responsive to a determination of a context (113) associated with the message; and can modify the message (127) in accordance with the context to provide a message having a re-configured style (145). The context can be determined from, for example, the recipient of the message (117), the content of the message (119), the context of the message (121), and/or a context of the processor (123). Optionally, pre-determined messages can be stored, wherein the user can select the message from the predetermined messages (101). In accordance with one or more embodiments, the message processor can be utilized in a communication device.

### FIELD OF THE INVENTION

The present invention relates in general to communications apparatus and message processing, and more specifically to modifying a style of a message.

### BACKGROUND OF THE INVENTION

The ability to receive and send messages on a communication system in a virtually instantaneous manner is quite popular with the general population. Unfortunately, many communication devices have user interfaces that are awkward to use and which therefore have a tendency to slow down the process of providing a message. As a consequence, the content of communications via such communication devices tends to be relative limited. Moreover, it is desirable to both parties involved in the communication to shorten the speed of communicating.

Some methods and system for providing communication have provided remedies to the above system drawbacks. For example, some communication units have an ability to store basic messages, often referred to as canned messages, which can be quickly retrieved later for use. Such messages may be initially provided with the communication unit, for example when delivered by the manufacturer, or may be downloaded and/or programmed at a later time. Some systems provide the user with the ability to enter, store and retrieve such messages for later use.

When using a communication system with message processing capabilities, many users still prefer to communicate with each other in a manner that is not only natural for them, but also is consistent with any pre-established or normal communication pattern. For example, when communicating with a close friend, messages tend to be more informal in tone, while communications with a business partner may be more formal in nature. Communication patterns may also vary according to, for example, the relationship of the individuals or groups engaged in communication with each other.

In some existing short message applications, canned message libraries that are provided by a communication unit give the user a choice of several pre-stored short messages. This saves the user from the somewhat time consuming process of inputting a text message manually.

These pre-stored messages are typically written in a fairly conservative tone, with consistent capitalization and punctuation. For example, all messages may be capitalized. They are intended to be generic to any number of situations and recipients.

Although pre-stored canned messages may convey the correct information including correct grammar, spelling and punctuation, they may not correspond to the communication pattern desired by the user.

### BRIEF DESCRIPTION OF THE DRAWINGS

The accompanying figures, where like reference numerals refer to identical or functionally similar elements and which together with the detailed description below are incorporated in and form part of the specification, serve to further illustrate a preferred embodiment and to explain various principles and advantages in accordance with the present invention.

FIG. 1 is a block diagram illustrating a simplified and representative example architecture for transforming a style of a message, suitable for use with a communication unit in accordance with various exemplary and alternative exemplary embodiments;

FIG. 2 is a diagram illustrating an exemplary message transformed in accordance with a re-configured style, in accordance with various exemplary embodiments;

FIG. 3 is a block diagram illustrating portions of an exemplary communication unit in accordance with various exemplary embodiments;

FIG. 4 is a flow chart illustrating an exemplary procedure for transmitting a message in a re-configured style, in accordance with various exemplary embodiments;

FIG. 5 is a flow chart illustrating an exemplary procedure for determining a style of a message based on a determination of context, in accordance with various exemplary embodiments; and

FIG. 6 is a flow chart illustrating an exemplary procedure for converting the style of a message, in accordance with various exemplary embodiments.

### DETAILED DESCRIPTION

In overview, the present invention relates to wireless communications devices or units, often referred to as communication units, such as cellular phone or two-way radios and the like having message creation and/or message processing capability. Such communication units can be associated with a communication system such as an Enterprise Network, a cellular Radio Access Network, or the like. Such communication systems may further provide services such as voice and data communications services. More particularly, various inventive concepts and principles are embodied in systems, communication units with message creation and/or processing capability, and methods therein for creating messages and/or processing messages associated with a call to another communication unit.

It should be noted that the term communication unit may be used interchangeably herein with subscriber unit, wireless subscriber unit, wireless subscriber device or the like. Each of these terms denotes a device ordinarily associated with a user and typically a wireless mobile device that may be used with a public network, for example in accordance with a service agreement, or within a private network such as an enterprise network. Examples of such units include personal digital assistants, personal assignment pads, messaging devices, MP3 players, and personal computers equipped for wireless operation, a cellular handset or device, or equivalents thereof provided such units are arranged and constructed for transmitting and/or receiving communications.

The communication systems and communication units of particular interest are those providing or facilitating voice communications services or data or messaging services over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof. Furthermore the wireless communication units or devices of interest may have short range wireless communications capability normally referred to as WLAN (wireless local area network) capabilities, such as IEEE 802.11, Bluetooth, or Hiper-Lan and the like using, for example, CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. According to one or more alternative embodiments, the wireless communication units or devices of interest may be connected to a LAN using protocols such as TCP/IP, UDP/UP, IPX/SPX, or Net BIOS via a hardwired interface such as a cable and/or a connector. The communication devices may be utilized in connection with, for example, Short Message Service (SMS) applications, instant messaging, and chat rooms or other communication architectures.

The present description is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. Indefinite articles such as “a”, “an” or no article are intended to mean “one or more”, “or at least one”, and the like.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

As further discussed herein below, various inventive principles and combinations thereof are advantageously employed to provide messages which suit the communication pattern of the user. One or more embodiments accordingly provide a message transformation processor which enhances communication between people or parties.

Messages can be transformed, in accordance with internal heuristics, to one or more of several writing styles and/or may be transformed to include other content.

The ease of use of a list of predetermined messages, for example canned messages or other messages already stored in memory, can be combined with the expressive power of different writing styles. The following list provides examples of alternative and exemplary styles that can be applied to textual content of messages, and exemplars of text according to the style:
Standard (“Where are you?”)
All lower case (“where are you?”)
All capital letters (“WHERE ARE YOU?”)
Mixed case (“wHeRe ArE yOu?”)
No punctuation (“Where are you”)
Humorously polite (“If you please, where are you, pray tell?”)
Abbreviated (“where ru?”)
Informal (“Where are you, dude?”)
Substitution (“Where can my Dave be?”)
Encoded in jargon (“20?”)
Match first two (“What around yogurt?”)
Match consonants (“Who ore eye?)
Match endings (“there stare thou?”)
Numeric (“20?”)
Pig latin (“erewha areya ouya?”)
Reverse (“you are where?”)
Scramble word (“hewre rea ouy”?)
Text message (“where r u?”)
Silly polite (“If you don't mind, where are you, pray tell?”)
Clean up (“Where are you?”)
Formal (“Dear John, Where are you? Thanks. Regards, Robert”)
Its cool (“So, where are you?”)
Jive it up (“Yo! where are you?”)
Simplify (“where are you”)

According to one or more alternative and exemplary embodiments, a library of multiple transformation styles can be selectively applied. When used in connection with, for example, terse communications that tend to be generated during mobile messaging, communication can be enriched and/or personality can be provided.

Various alternative styles for transforming messages can be provided.

The following section provides scenarios or examples of communications which can be achieved according to one or more exemplary and alternative exemplary embodiments.

### EXAMPLE 1

Bob is a business user and needs to send a message to a colleague. He opens the list of messages provided on his communication device, for example, a canned message, and selects one of the messages. The message he selected is immaculately capitalized and punctuated, and is too formal and stuffy for his usual communication habits with this particular colleague. In operation of the message re-configuration process, Bob requests that the style be adjusted to be more informal. According to alternative and exemplary embodiments, the formal/informal style is a sliding scale; as the message becomes more informal, slang and humor elements can be added. The message is transformed according to the informal style. Bob can send the message to the colleague from the communication device when he is satisfied with the message. The processor associates the selected style with this particular recipient. When Bob next selects a message for this particular recipient, the processor can automatically determine that the informal style is an appropriate style.

### EXAMPLE 2

Jason, a high school student, has received a message “where are you” from his friend Brandon. He composes a reply, saying “i am at jay's house.” Jason previously entered a preference for proper capitalization, and the processor is aware of this preference and so automatically capitalizes the message to “I am at Jay's house.” Jason can further re-configure the message in accordance with one or more styles. In the present example, Jason selects Yoda mode, which alters grammar. The message becomes “At Jay's house, I am.” Jason further desires to have the message reflect a Jay's nickname. One or more alternative and exemplary embodiments provide for associating nicknames with proper names. Upon selection of the nickname style, the processor substitutes Jay's nickname “The Calculator” into the message. The message, re-configured in accordance with the Yoda mode and with the nickname, is “At The Calculator's house, I am.”

### EXAMPLE 3

Sally wants to send a MMS (Multimedia Messaging Service) message to a friend. The MMS provides a conventional greeting card application, in which Sally selects a variety of text and visual elements to compose a message. Sally invokes the processor to re-configure the message in accordance with an optional magnetic poetry style. The processor provides Sally with one or more sets of words, for example random words, that can be inserted into the message. The processor optionally can prompt Sally at each new word to insert one of the magnetic poetry words. According to one or more alternative and exemplary embodiments, the processor can include a conventional predictive input feature. Utilizing the magnetic poetry words, Sally has created a zany but coherent message that uses the proposed words but still makes sense. She can transmit the message that has been re-configured in accordance with the selected style.

### EXAMPLE 4

Sam is in school and likes to play with messaging in connection with secret communications with his friends. He composes a message utilizing one or more embodiments, to his friend, and encodes it with “match first two letters” encoding. The original message is “the raisins of wrath”. The encoded message becomes “thankless rabbinic offenses wrench”, with the first two letters of each encoded word matching the original words. He sends the encoded message to his friend. Sam's friend, after receiving the message, can invoke the processor to decode the message. In accordance with alternative and exemplary embodiments, the message is sent un-encoded, e.g., in plain text, but includes an indicator of the encoding. When the message is received, the recipient communication unit detects the indicator of the encoding, encodes the message, and displays the message with the encoding. The recipient communication unit can previously have received the encoding associated with the indicator, so as to permit proper encoding and decoding of the message.

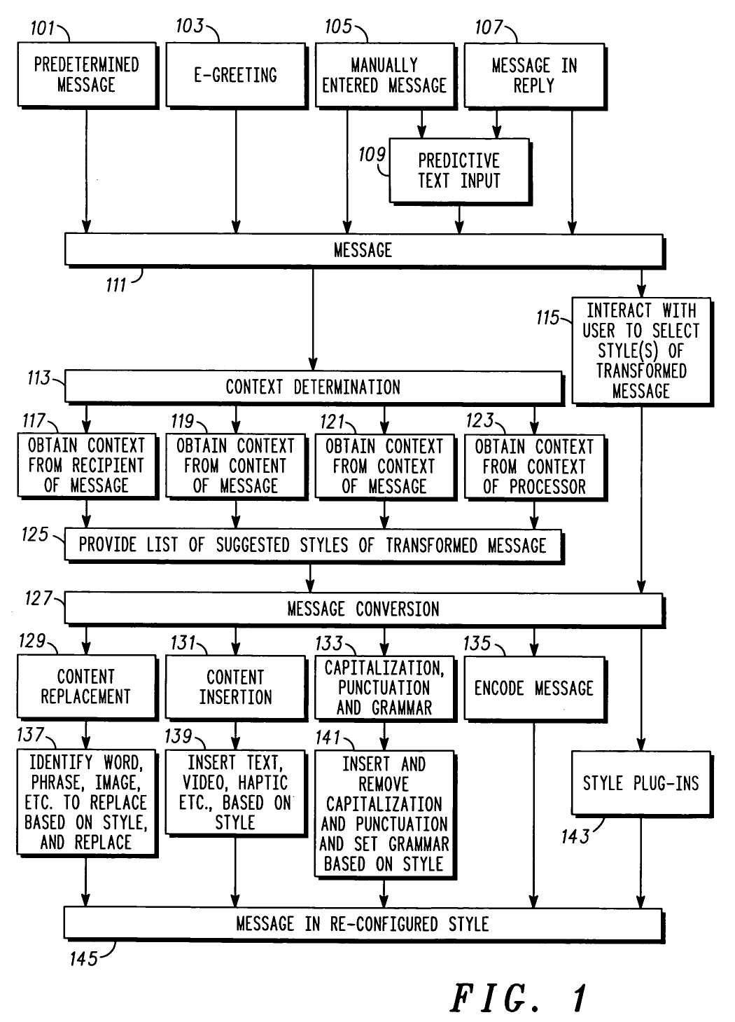

Referring now to FIG. 1, a system and process for transforming a style of a message will be discussed and described. FIG. 1 is a block diagram illustrating a simplified and representative example architecture of a process for transforming a style of a message, which advantageously can be implemented, for example, on a processor of a communication unit in accordance with various exemplary and alternative exemplary embodiments. In overview, a message 111 is obtained by the process. One or more styles to be applied to the message 111 are determined, for example by determining one or more contexts 113, or by interacting with the user 115. The one or more styles are applied to the message 111, so that the message 111 is converted in accordance with the one or more styles 127, while generally maintaining the same semantic meaning, to obtain the message in a re-configured style 145.

Blocks 101-109 of FIG. 1 provide exemplary and alternative exemplary embodiments for obtaining the message 111 by the process, although creation and entry of the message is not limited to the illustrated means. In the illustrated example, the message can be input, for example by being selected from one of numerous pre-determined messages 101. Certain communication units are available with canned messages, or messages that are provided by the communication unit manufacturer. The messages are intended for the convenience of the user, so as to avoid entry of text which can be particularly tedious in connection with, for example, a cellular telephone. These messages tend to be impersonal and meticulously capitalized and punctuated. In addition, one or more types of communication units provide a facility whereby a user can enter one or more messages that can be used repeatedly. These can be somewhat more specific to the user, but are again intended for use in many situations for numerous recipients.

As another alternative for inputting a message, one or more embodiments provides for inputting an electronic greeting 103 as a message. Numerous conventional applications are available whereby a user can select an electronic greeting card. An electronic greeting card can include a video portion, an audio portion, and/or a text portion. If text is not provided in an electronic greeting card, the conventional greeting card application can prompt the user or otherwise interact with the user in order to associate text with the interactive greeting card. Some conventional electronic greeting card applications provide that the electronic greeting cards are associated with a topic, genre or category, for example, “birthday,” “late birthday,” “holiday”, etc.

The alternative and exemplary embodiments illustrated in FIG. 1 also provide for a manually entered message, 105, and for a message in reply to a received message 107. In order to manually enter a message 105, the process can interact with the user in the conventional manner to provide a message, e.g., to be sent to another recipient. Such a message may incorporate text, audio, video, etc., according to the limitations proscribed by the process. Similarly, where a user has received a message, the process can provide a message in reply 107 to the message. Conventionally, the process can interact with the user to provide the reply message.

In accordance with one or more alternative embodiments, the process optionally functions in accordance with a predictive text input process 109, in order to ease the user's provision of text. Various predictive text input processes are available, and can be utilized to implement this optional function.

Further, certain communication units can provide that a pre-determined message can be selected and can be combined with other messages. For example, according to one or more embodiments, a user can input a text message, and can select a canned message to incorporate into the text message.

Once the message 111 has been selected, entered, composed, or otherwise provided in the communication unit, the message can be transformed in accordance with one or more styles. The styles to be applied to the message 111 are determined, for example by determining one or more contexts, or by interacting with the user. Blocks 113-125 illustrate exemplary and alternative exemplary embodiments, wherein the process determines one or more styles that may be applied to the message.

According to one or more embodiments, a context applicable to personalizing the message is determined from the recipient of the message, at 117. A recipient of a message is generally associated with a name, and names can be stored in association with preferred styles. Preferred styles associated with recipients can be determined from, for example, user input and/or styles associated with messages previously received from and/or sent to the recipient. For example, the user may have previously interacted with the process to store one or more particular styles with a particular recipient. Hence, as an example, the recipient “Joe” may be associated with the Yoda grammar and the all lower case style. According to one or more embodiments, a recipient of a message can be extrapolated from additional information available from the process to be associated with a company or a geographic location, which can be determined from, for example, a telephone book stored in the communication unit. The process can determine from the expanded recipient information that, for example, the recipient is located in a particular geographic area or is associated with a particular company. The process can include storage associating geographic areas and/or companies with particular styles. For example, geographic areas in Texas can be associated with a Texas style, and users associated with particular companies can be associated with formal styles. As another example of determining recipient context, the recipient can be associated with a particular group, and a list in the process can store styles associated with one or more groups. For example, a group of buddies or colleagues can be associated with a slang style or a formal style, respectively.

According to one or more embodiments, a context applicable to personalizing the message is determined from the content of the message, at 119. Message content can include, for example, the text in the message, the video, audio, or haptic associated with the message. The content of the message can be reviewed, for example the words can be parsed, to determine if particular terms occur in the message. The process can have storage of particular terms and styles associated therewith. For example, geographic terms can be associated with particular styles, names can be extracted from content and associated with styles (as described, for example, in connection with recipients), the message can be searched for particular keywords associated with particular styles, etc. Where the content of the message yields a term occurring in one or more lists of styles, the style can be determined accordingly.

Further in accordance with exemplary and alternative embodiments, a context applicable to personalizing the message is determined from the context of the message, at 121. Message context can include, for example, information associated with the message that is not typically regarded as the viewable part of the message. As an example, a message that began as a conventional electronic greeting may be associated in the conventional manner with a topic or genre; the topic or genre can be utilized to search a list of keywords that are associated with styles, to determine one or more appropriate contexts of the message. An electronic greeting message generated under the topic of condolences hence can result in a formal style.

According to one or more embodiments, a context applicable to personalizing the message is determined from the context of the communication unit or the processor itself, at 123. Conventional communication units can include sensors for determining their states, such as motion sensors, global positioning systems or other methods for determining geographic locations. In addition, conventional communication units can be set for certain modes, such as “meeting” mode; these modes can determine a context of the unit. The mode, geographic location, or indication of “still” or “in motion” can be utilized to search a list of keywords that are associated with styles, to determine one or more appropriate contexts of the message. For example, a communication unit that is determined to be located in Paris can result in a “French” style; a communication unit that is “in motion” can be determined to result in a “busy” style.

According to exemplary embodiments and/or alternative embodiments, the process is provided with one or more styles, in a library of styles that can be applied to messages. One or more lists of keywords can be provided, wherein a keyword is associated with one or more styles. For example, a list of geographic keywords can be provided, such that “France” or “Paris” corresponds to the “French” style; and “California” corresponds to the “informal” style. Keywords could include, for example, a list of words associated with a popular movie, and those words can be associated with a style appropriate to the movie. The Yoda style, for example, can be associated with terms unique to the Star Wars movies.

According to one or more embodiments, when the process reviews the message and determines one or more appropriate contexts, the contexts are listed so that the user can interact with the process to select one or more of the styles corresponding to the message contexts. Alternatively, the styles corresponding to the context(s) can be applied automatically to the message.

Alternatively, and/or in connection with the foregoing, the process can provide a list of available styles in the library of styles that can be applied to the messages, 115. This can be implemented, for example, by providing the user with a selectable list of the names of the styles. The user can scroll through the list of names and select one or more styles to be applied to the message.

It should be noted that context of the message can be determined in connection with one or more of the foregoing. Consequently, a message can result in one or more appropriate contexts corresponding to styles that can be applied to the message.

Having determined both the message and its context and the style or styles to be applied thereto, the message 111 is converted in accordance with the one or more styles 127, while generally maintaining the same semantic meaning, to obtain the message in a re-configured style. In accordance with the exemplary illustrated architecture, one or more of the styles can include elements that call for replacement of message content 129, insertion of message content 131, correction or modification of capitalization, punctuation and grammar 133, and/or encoding of the message 135. According to exemplary and alternative exemplary embodiments, the style of a message can be transformed via a plug-in 143, subroutine call, process, or the like.

If the style calls for replacement of content 135, then the process parses the message to identify words, phrases, images, etc., that the style calls for replacement. The process then replaces the words, phrases, images, etc., in accordance with the style. As an example of a replacement style, a style can provide for replacement of names with nicknames, and certain slang styles can call for replacement of common phrases with the equivalent slang phrases. As an alternative example of a replacement style, the processor can provide a “magnetic poetry” feature, providing random or pseudo-random replacement words, for which the user is prompted at various times to select one for use as a replacement word. If the message includes video, audio, haptic and/or smell data, the style can provide for the replacement of the data with alternative video, audio, haptic and/or smell data corresponding to the style.

Where the style calls for insertion of content 131, the process parses the message to identify appropriate locations for insertion of content. For example, in a formal style, the process will identify the start and end of the message in order to insert a formal salutation and formal sign-off. As another example, where the style is “cool”, the process identifies appropriate locations to insert the terms “like” and “dude”. Insertions can be provided not only as text, but also as video, audio, and/or haptic. For example, an “angry” style can call for the insertion of a vibration and buzzing tone into the message; a geographic location can call for the insertion of video (e.g., corresponding to the geographic area). The message can be revised accordingly.

One or more embodiments provide for modification of capitalization, punctuation and grammar 133. The process can search for and insert or remove capitalization and/or punctuation in accordance with the style, and/or revise the grammar of the message according to the style 141. Known techniques provide for correcting capitalization and/or punctuation. Further, known techniques provide for parsing a message sufficient to revise the grammar. A message can be revised in accordance with styles that call for modification of capitalization, punctuation and grammar.

One or more embodiments provide that the style corresponds to encoding for the message, whereby text is replaced with alternative text. For example, certain styles may call for replacement of some or all of the words in the message according to particular rules, for example, the first two letters of each word determine the replacement word. As another example, a message can be encoded into, e.g., pig Latin.

It is envisioned that the process can accommodate one or more styles that can be provided independently or otherwise downloaded into the process, perhaps independent of the main processing code. Hence, the process can provide for style plug-ins 143. The style plug-ins can accommodate other styles that are created by users for the purpose of converting messages. In accordance with one or more alternative and exemplary embodiments, style plug-ins can accommodate, for example, existing language style translation programs.

It should be noted that the styles to be applied to the message can result in operation of content replacement, content insertion, capitalization, punctuation and grammar, encoding, and/or operation of the style plug-ins. Consequently, one or more selected styles to be applied to a message can result in a message that is re-configured in accordance with one or more styles.

It will be appreciated that the message thus transformed has retained its general semantic meaning. In accordance with one or more embodiments, the message that has been transformed in accordance with the one or more styles can be transmitted to a recipient. For example, the message could be transmitted from a communication device, such as a cell phone or a PDA (personal digital assistant).

FIG. 2 is a diagram illustrating an exemplary message transformed in accordance with a re-configured style, in accordance with various exemplary embodiments. In overview, FIG. 2 illustrates a message 201, which is provided to one or more embodiments of a message processor 205, which provides a re-configured message 211 in accordance with one or more styles.

The message 201 in the present example contains text 203. The text is a message, “Tina, greetings from Paris. Bob.” The user may have selected this message in various ways, for example, text entry, or selection of a pre-determined message from a list of messages.

The message is provided to the message processor 205. For example, messages can be automatically submitted to the message processor 205, and/or the user can interact with the communication unit to indicate that the message should be submitted to the message processor 205. The message processor 205 processes the message, as discussed, for example, in connection with FIG. 1. In the present example, the message processor 205 can detect from the context of the communication unit that the geographic location of the communication unit is Paris, and one of the styles determined by the message processor 205 is “French”. Alternatively, the message processor 205 can detect from the content of the message, e.g., the word “Paris”, that an appropriate style is “French”. Further, the message processor 205 can detect that names in the nickname database are present in the message, and consequently can determine that a “nickname” style is appropriate. In addition, the message processor 205 can detect the recipient Tina and determine that an informal style is associated with the recipient “Tina.” The message processor 205 can automatically proceed to convert the message in accordance with these styles. According to alternative exemplary embodiments, the message processor 205 can interact with the user to determine which, if any, of the styles should be applied to the message. In this instance, the context appropriate to the message is determined to be the “French,” “nickname,” and “informal” styles.

The message processor 205 provides a re-configured message 211 in accordance with the selected styles. Here, the message processor replaced the name “Bob” with the nickname “Bobby” 213 in accordance with the nickname style. Also, the message 209 has been made “informal” by changing “greetings from Paris.” to “Paris is grand!!”. Further, the message 209 has been transformed in accordance with the French style by inserting an appropriate French image 207 and by replacing English words with French words: “Paris est grand!!”.

Hence, the message 211 is in a re-configured style which suits the communication patterns of the particular user and is appropriate in the context of the user and the recipient. If the communication unit is set in a mode to automatically determine the styles and/or to automatically transmit the messages in the determined styles, the message can be rapidly transformed to communication patterns and context appropriate to the user and the recipient.

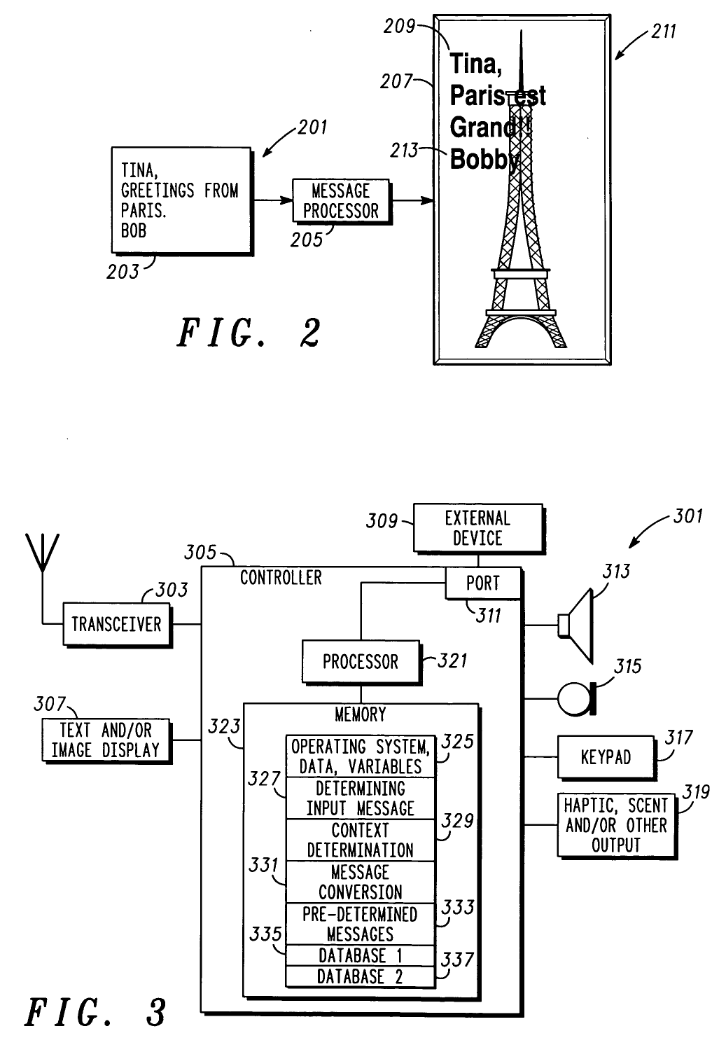

FIG. 3 is a block diagram illustrating portions of an exemplary communication unit 301 in accordance with various exemplary and alternative exemplary embodiments. The communication unit 301 may include all intercoupled as shown, a controller 305, a transceiver 303, a text and/or image display 307, a speaker 313, a microphone 315, a haptic, scent and/or other output device 319 for providing haptic, e.g., vibratory, visual alert, scent, and/or other alert, and/or a user input device such as a keypad 317. A headset (not shown) may incorporate the speaker 313 and microphone 315. The controller 305 further comprises a communication port 311 for communication with an external device 309, a processor 321, a memory 323, and the like generally intercoupled as depicted.

The processor 321 may comprise one or more microprocessors and/or one or more digital signal processors. The memory 323 is coupled to the processor 321 and may comprise one or more of a read-only memory (ROM), a random-access memory (RAM), a programmable ROM (PROM), and/or an electrically erasable read-only memory (EEPROM). The memory 321 may include multiple memory locations for storing, inter alia, an operating system, data and variables 325 for overall controlled of execution of the processor 321; computer programs for causing the processor to operate in connection with various functions such as determining the input message 327, determining the context appropriate to the message 329, message conversion in accordance with the determined styles 331, and/or other processing (not illustrated); memory 333 for pre-determined messages; a database 335 of various other data, e.g., tables used for parsing messages and determining context and other tables; and/or a database 337 for other information, such as phone books and the like used by the processor 321. The computer programs stored in the memory for example, in ROM or PROM are arranged to direct the processor 321 in controlling the operation of the communication unit 301.

According to one or more exemplary and alternative embodiments, the processor 321 may be programmed to interact with the user, for example as described above. In addition, the processor may be programmed to provide haptic, scent and/or other output to the user by way of the haptic, scent and/or other output device 319. The device 319 may use a conventional vibration or audible alerting mechanism, visual alert, and/or other alert, or a combination thereof.

The user may input information and can invoke functions accessible through the user input device 317. The user input device 317 may comprise one or more of various known input devices, such as a keypad, a computer mouse, a touchpad, a touch screen, a trackball, and/or a keyboard. The text and/or image display 307 may present, for example, messages or other information, such as received messages and images, to the user by way of a conventional liquid crystal display (LCD) or other visual display.

Referring now to FIGS. 4-6, a process for transforming a style of a message will be discussed and described. FIGS. 4-6 provide flow charts illustrating, respectively, an overall process for transmitting a message in a re-configured style, a process for determining one or more styles of a message based on a determination of the context, and a process for converting the style of a message. The process can advantageously be implemented on a processor of a communication unit, for example as illustrated in connection with FIG. 3 or other device or apparatus with similar capabilities.

FIG. 4 is a flow chart illustrating an exemplary procedure for transmitting a message in a re-configured style 401, in accordance with various exemplary embodiments. At 403, the message to be transmitted is determined. According to one or more embodiments, the message can be determined in accordance with one or more conventional procedures, for example, by the communication unit interacting with the user so that the user can select a pre-determined (e.g., canned) message, by the communication unit interacting with the user to reply to a message and entering text via the communication unit or the external device, by the communication unit interacting with the user to enter text, and/or by the communication unit interacting with the user wherein the user operates another message generating process such as an electronic greeting application.

According to one or more exemplary and alternative exemplary embodiments, at 405, the process can determine whether the user selected one or more particular styles to be applied to the message. For example, the process can provide a list of styles available in a library of styles, and the user optionally can select one or more of the styles.

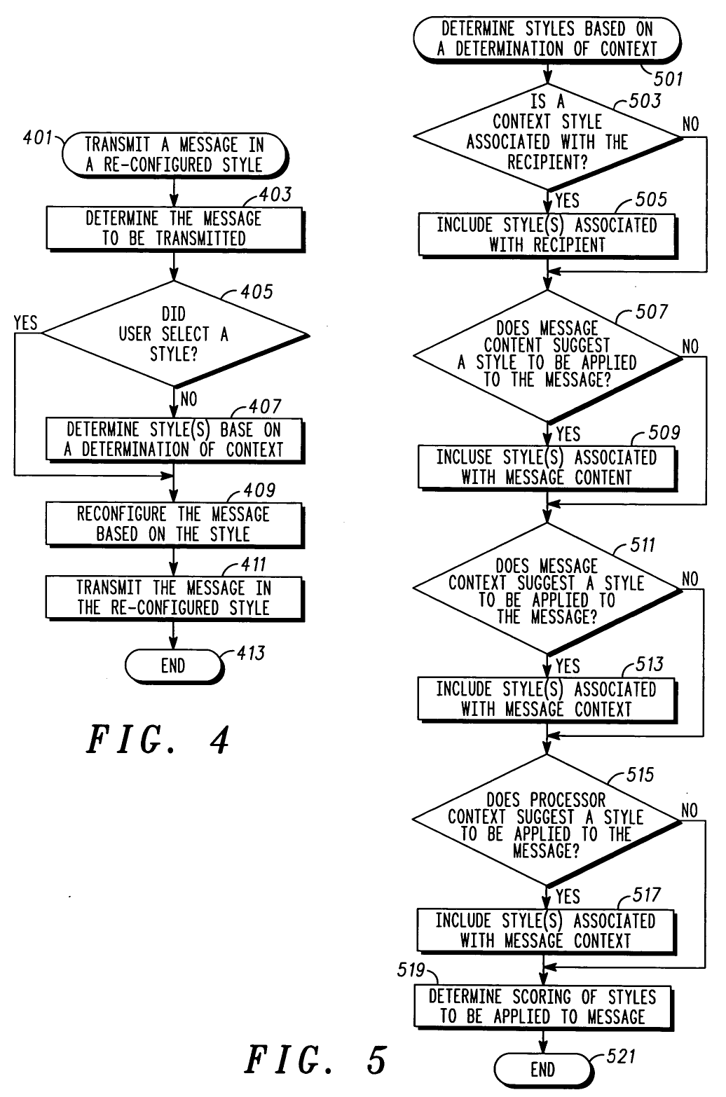

If the user did not select one or more particular styles to be applied to the message, the process can determine one or more styles to be applied to the message, based on a determination of a context, at 407. (FIG. 5 below describes in more detail an exemplary embodiment of determining a style based on a determination of a context.)

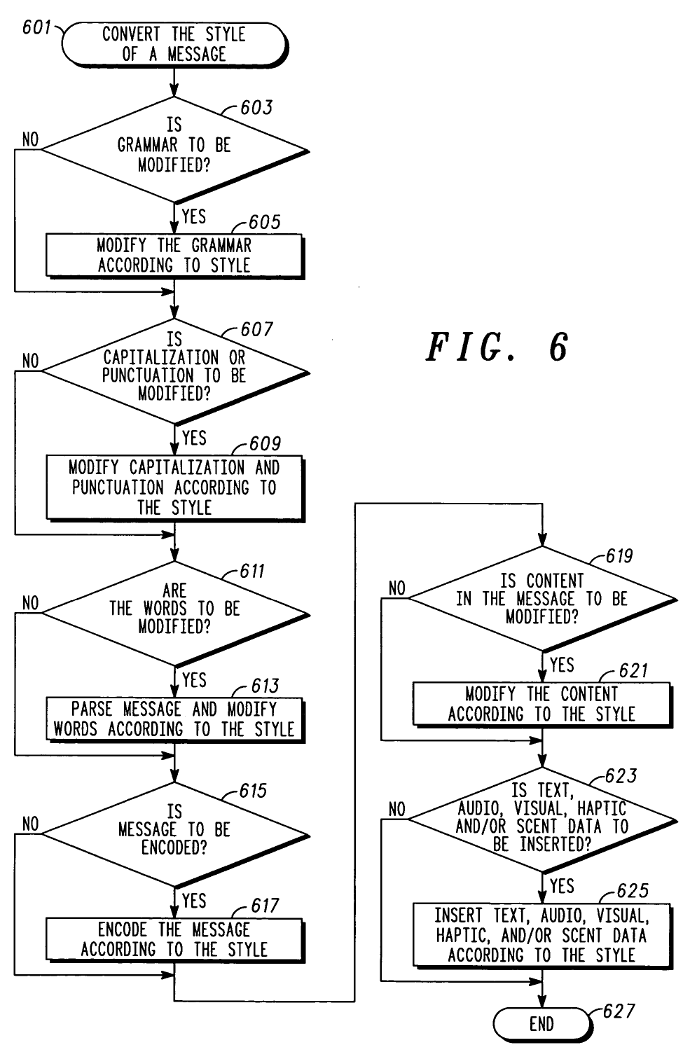

When the styles are determined, the process can reconfigure the message based on the style 409. (FIG. 6 below describes in greater detail one or more exemplary embodiments of converting the style of a message.) The message is then re-configured in accordance with the context and/or styles. Advantageously, the re-configured message retains the general semantic structure and meaning of the original message.

The re-configured message can be transmitted 411, in accordance with conventional procedures for transmitting messages. At 413, processing for transmitting the message in the re-configured style ends.

FIG. 5 is a flow chart illustrating an exemplary procedure for determining a style of a message based on a determination of context 501, in accordance with various exemplary and alternative exemplary embodiments. In overview, the process determines whether there is a context and hence a style associated with the recipient 503, whether the message content itself suggests a style to be applied to the message 507, whether the message context suggests a style to be applied to the message 511, and whether the context of a device in which the process is executing (e.g., in the communication unit) suggests a style to be applied to the message 515. In accordance with one or more embodiments, the styles that are suggested can be used in transforming the message. The determination of styles based on a determination of context will now be discussed in more detail in connection with one or more exemplary embodiments.

At 503, the process determines whether there is a context associated with the recipient. In accordance with one or more embodiments, the recipient can be determined from, for example, the number to which the message is being sent, the caller identifier of the recipient, and/or the name of the recipient (e.g., in an electronic message). A recipient of a message can be a name or can be associated with a name. Names and/or other recipient identification information can be stored in association with one or more styles. The one or more styles associated with a particular recipient can be determined from, for example, user input, one or more styles associated with a message previously received from the recipient, and/or one or more styles associated with a message previously sent to the recipient. According to one or more embodiments, further context can be extrapolated from the recipient of a message, due to additional information that optionally can be available from the communication unit. For example, a list of contacts in the communication unit can associate a particular recipient with, for example, a company, a geographic location, or a particular group. The process can refer to, for example, a list of companies, geographic locations, and/or groups, and the styles corresponding thereto. For example, a group of buddies or colleagues can be associated with a slang style or a formal style, respectively. According to one or more embodiments, a predetermined style can be associated with frequent messaging, and can be determined as the style by determining a frequency of exchanging messages with, e.g. messaging the recipient. If there is one or more contexts or styles associated with the recipient, the process can include the one or more styles, 505.

The process can determine whether the message content itself suggests a style to be applied to the message 507. In accordance with one or more embodiments, the message content can include, for example, the text in the message, and/or the video, audio, or haptic data associated with the message. The content of the message itself can be reviewed, for example words in the message can be parsed, scanned, compared, or similarly analyzed, to determine if particular terms and/or phrases occur in the message. The communication device can include a list of the particular terms and/or phrases, and the corresponding styles associated therewith. The content of the message can yield one or more contexts and hence one or more styles. If there is one or more contexts or styles associated with the message content, the process can include the one or more styles, 509.

The process can determine whether the message context suggests a style to be applied to the message 511. Message context can include, for example, information associated with the message that is not typically regarded as the viewable part of the message. As an example, a message that began as a conventional electronic greeting may be associated in the conventional manner with a topic or genre; the topic or genre associated with the electronic greeting can be a message context. If there is one or more contexts or styles associated with the message context, the process can include the one or more styles, 513.

The process can determine whether the context of the device in which the process is running (e.g., in the communication unit) suggests a style to be applied to the message 515. The process and/or the communication unit can be reviewed for information that indicates a state of the communication unit. Conventional communication units can include sensors for determining their states, such as motion sensors, global positioning systems or other methods for determining geographic locations. In addition, conventional communication units can be set for certain modes, such as “meeting” mode; these modes can determine a context of the unit. The mode, geographic location, or indication of “still” or “in motion” can indicate a context. The context can be provided in a list of contexts and associated styles. If there is one or more contexts and hence one or more styles associated with the processor context (or the communication unit), the process can include the one or more styles, 517. At 519, where there is more than one suggested style, the process can optionally determine a scoring of the styles, in order to provide a weighted list of most likely styles. In determining the scoring, the process can consider, for example, whether there is a most common style suggested for this message, whether there are conflicting styles for this message, whether a style is most recently and/or most frequently selected. Further, in determining the scoring, styles resulting from certain contexts may be more important, for example, where the style was based on the recipient, the time of day, and/or a history of styles used for the sender/recipient of the message. When multiple styles are determined, the process optionally interacts with the user to select one or more of the styles. The process ends at 519.

FIG. 6 is a flow chart illustrating an exemplary procedure for converting the style of a message 601, in accordance with various exemplary and alternative exemplary embodiments. Exemplary and alternative exemplary embodiments of the system for providing the conversion of the style of a message have been previously discussed in connection with FIG. 1, and hence FIG. 6 provides an exemplary flow chart. According to alternative embodiments, and in overview, one or more styles are associated with one or more of the following: a grammar modification 603, a capitalization and/or punctuation modification 607, a word modification 611, a message encoding 615, a content modification 619, and/or a text, audio, visual, haptic and/or scent data insertion 623.

According to one or more embodiments, one or more tables and/or subroutines can be provided to associate the style with the various modifications called for in connection with the style.

The process can check whether the style is associated with one or more grammar modifications 603. If so, the process can modify the grammar in the message according to the style 605.

The process can check whether the style is associated with one or more capitalization and/or punctuation modifications 607. If so, the process can modify the capitalization and/or punctuation in the message according to the style 609.

The process can check whether the style is associated with one or more word modifications 611. If so, the process can parse the message and modify words (or phrases) in accordance with the style 613.

The process can check whether the style is associated with one or more message encodings 615. If so, the process can encode the message in accordance with the style 617.

The process can check whether the style is associated with one or more content modifications 619. If so, the process can determine content in the message that can be modified, and can modify the content of the message accordingly 621.

The process can check whether the style is associated with one or more text, audio, visual, haptic and/or scent data insertions 623. If so, the process can insert the text, audio, visual, haptic, and/or scent data into the message 625.

Processing for converting the style of the message ends 627, and the message has been converted in accordance with the selected one or more styles.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A message processor comprising:
a processor, wherein the processor is configured to facilitate determining a message to be transmitted; to facilitate selecting at least one style responsive to a determination of a context associated with the message; and to facilitate modifying the message in accordance with the at least one context to provide a message having a re-configured style;
wherein the context is determined from at least one of: the recipient of the message, the content of the message, the context of the message, and a context of the processor.

2. The message processor of claim 1, wherein the processor is utilized in a communication device.

3. The message processor of claim 1, wherein the processor is further configured to facilitate applying the at least one style to the message to at least one of: modify a format of the message, modify a grammar of the message, modify a capitalization in the message, encode the message, modify words in the message, modify content in the message, and insert at least one of text, audio, visual, haptic, and scent data in the message.

4. The message processor of claim 1, wherein the modifying of the message maintains a semantic meaning of the message.

5. The message processor of claim 1, wherein the context is further determined as at least one of: associated with at least one predetermined style for the recipient; associated with at least one predetermined style for the sender; if the message is a reply to a received communication, associated with a style of the received communication; associated with at least one predetermined style for frequent messaging, in relation to frequency of messaging the recipient; associated with at least one predetermined style corresponding to a geographic location of the sender or recipient; and associated with at least one predetermined style corresponding to a group to which the recipient belongs.

6. The message processor of claim 1, wherein the processor is further configured to facilitate, responsive to a name in the message, substituting for the name, a nickname from information representing nicknames and corresponding names stored in a memory.

7. The message processor of claim 1, wherein the processor is further configured to facilitate at least one of: including an image, responsive to the at least one style, in the message; and if the message includes at least one of video, audio, haptic and smell data, modifying the at least one of video, audio, haptic and smell data, responsive to the at least one style.

8. The message processor of claim 1, further comprising a user interface connected to the processor, wherein the processor is further configured to facilitate at least one of: (i) in accordance with the at least one style, prompting the user to select words from a pre-determined set of words, to be included in the message; and (ii) entering text in the message in accordance with a predictive text input process.

9. A message processor comprising:
a memory configured to store a plurality of pre-determined messages; and
a processor, coupled to the memory, wherein the processor is configured to facilitate determining, responsive to a user, at least one message from the plurality of predetermined messages; to facilitate selecting at least one style; and to facilitate modifying the message to provide a message re-configured in accordance with the at least one style.

10. The message processor of claim 9, wherein the processor is utilized in a communication device.

11. The message processor of claim 9, wherein the at least one style is automatically selected based on a determination of at least one of: the recipient of the message, the content of the message, the context of the message, and a context of the message processor.

12. The message processor of claim 9, wherein the processor is further configured to facilitate applying the at least one style to the message to at least one of: modify a format of the message, modify a grammar of the message, modify a capitalization in the message, encode the message, modify words in the message, and insert at least one of text, audio, visual, haptic, and scent data in the message.

13. The message processor of claim 9, wherein the modifying of the message maintains a semantic meaning of the message.

14. The message processor of claim 9, wherein the style is further determined as at least one of: associated with at least one predetermined style for the recipient; associated with at least one predetermined style for the sender; if the message is a reply to a received communication, associated with at least one style of the received communication; associated with at least one predetermined style for frequent messaging, in relation to frequency of messaging the recipient; associated with at least one predetermined style corresponding to a geographic location of the sender or recipient; and associated with at least one predetermined style corresponding to a group to which the recipient belongs.

15. The message processor of claim 9, wherein the processor is further configured to facilitate, responsive to a name in the message, substituting for the name, a nickname from information representing nicknames and corresponding names stored in a memory.

16. The message processor of claim 9, wherein the processor is further configured to facilitate at least one of: including an image, responsive to the at least one style, in the message; and if the message includes at least one of video, audio, haptic, and smell data, modifying the at least one of video, audio, haptic, and smell data, responsive to the at least one style.

17. The message processor of claim 9, further comprising a user interface connected to the processor, wherein the processor is further configured to facilitate at least one of: (i) in accordance with the at least one style, prompting the user to select words from a pre-determined set of words, to be included in the message; and (ii) entering text in the message in accordance with a predictive text input process.

18. A communication device comprising:
a receiver, for receiving communications, when operably connected to a network;
a processor, coupled to the receiver, wherein the processor is configured to facilitate determining, responsive to a message received via the receiver, at least one style of the message; and to facilitate, responsive to the style, modifying content of the message in accordance with the style; and
a display communicating with the processor, wherein the processor is further configured to facilitate displaying the message with modified content on the display, responsive to user request.

19. The communication device of claim 18, wherein the style is determined responsive to an indicator, associated with the communication, corresponding to the at least one style.

20. The communication device of claim 18, further comprising a user interface, wherein the processor is further configured to facilitate, responsive to user request, decoding the message in accordance with the at least one style.

21. A method of processing messages, comprising the steps of:
determining a message to be transmitted;
determining, responsive to the message, a context associated with the message;
selecting at least one style responsive to the determination of the context associated with the message;
modifying the message in accordance with the at least one context to provide a message having a re-configured style;
wherein the context is determined from at least one of: the recipient of the message, the content of the message, the context of the message, and a context of the processor.

22. The method of claim 21, implemented in a communication device.

23. The method of claim 21, wherein the context is further determined as at least one of: associated with at least one predetermined style for the recipient; associated with at least one predetermined style for the sender; if the message is a reply to a received communication, associated with a style of the received communication; associated with at least one predetermined style for frequent messaging, in relation to frequency of messaging the recipient; associated with at least one predetermined style corresponding to a geographic location of the sender or recipient; and associated with at least one pre-determined style corresponding to a group to which the recipient belongs.

24. The method of claim 21, further comprising responsive to a name in the message, substituting for the name, a nickname from information representing nicknames and corresponding names stored in a memory.

25. The method of claim 21, wherein the modifying of the message maintains a semantic meaning of the message.

26. A method of processing messages, comprising the steps of:
determining responsive to a user, at least one message from a plurality of pre-determined messages;
selecting at least one style to be applied to the at least one message;
modifying the message, to provide a message re-configured in accordance with the at least one style.

27. The method of claim 26, implemented in a communication device.

28. The method of claim 26, wherein the style is automatically selected based on a determination of at least one of: the recipient of the at least one message; the content of the at least one message; the context of the at least one message; and a context of the processor.

29. The method of claim 26, wherein the style is further determined as at least one of: associated with at least one predetermined style for the recipient; associated with at least one predetermined style for the sender; if the message is a reply to a received communication, associated with a style of the received communication; associated with at least one predetermined style for frequent messaging, in relation to frequency of messaging the recipient; associated with at least one predetermined style corresponding to a geographic location of the sender or recipient; and associated with at least one pre-determined style corresponding to a group to which the recipient belongs.

30. The method of claim 26, further comprising responsive to a name in the message, substituting for the name, a nickname from information representing nicknames and corresponding names stored in a memory.
